(19) United States
(12) Patent Application Publication
(10) Pub. No.: US 2005/0244549 A1
(43) Pub. Date: Nov. 3, 2005

(54) Disposable pre-filled food topping package/dispenser and associated methods

(75) Inventor: Trent W. Ling, Orlando, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Ling Communications, Inc., Orlando, FL (US)

(21) Appl. No.: 10/837,968

(22) Filed: May 3, 2004

(51) Int. Cl. A23B 4/00

(52) U.S. Cl. 426/115

(57) ABSTRACT

The disposable prefilled food condiment dispenser includes an elongated hollow agitator having an openable end and another end connected to a reservoir filled with a food condiment, such as popcorn topping. A food container clip may extend from the agitator or the reservoir to removably attach the dispenser to a food container. The openable end of the elongated hollow agitator preferably has an opening and a removable cap or seal to close the opening. Popcorn topping, e.g. butter, can easily be distributed throughout a popcorn bag, box or bucket, all at once, or periodically, depending upon the preferences of the user. The dispenser is portable, and it does not require the shaking of the container and associated spilling of popcorn. Also, different flavors and different caloric choices may be provided.

### RELATED APPLICATION

The present invention was first described in Disclosure Document No. 542487 filed on Dec. 2, 2003.

### FIELD OF THE INVENTION

The present invention relates to the field of food topping packaging, and, more particularly, to the field of disposable pre-filled food topping packages and dispensers and related methods.

### BACKGROUND OF THE INVENTION

Movie theaters typically provide butter-flavored oil (hereinafter referred to as simply “butter”) for patrons who purchase popcorn. For example, it is known to add butter with the kernels of corn during popping. However, this approach may result in stale popcorn and does not accommodate requests for un-buttered popcorn. More commonly today, theaters utilize butter-dispensing machines which dispense a single narrow flow of butter as the user is required to move the bag, box or bucket of popcorn around to try to spread the butter evenly over the top layers of the popcorn. The user must then shake the bag, box or bucket of buttered popcorn upward and then dispense more butter onto the new top.

The butter dispensing machines are the chosen method of buttering movie theater popcorn today, despite numerous disadvantages discussed below. Firstly, only the top portion of the popcorn may be treated with butter, thus, the top portion is displeasingly saturated in butter, whereas if the same amount of butter was evenly distributed throughout the popcorn, it would be more satisfying. Beyond this, the middle and bottom portions of popcorn are hardly buttered at all and are not enjoyed nearly as much by those patrons preferring buttery popcorn. An approach to this problem includes the patrons re-visiting the butter dispensing machine 2-3 times or more during a movie.

Sharing the popcorn is a problem if one person prefers butter and the other does not prefer butter, or even if preferences differ in the amount of butter desired. Also, the use of the machines is messy (butter often will be spilled over the sides of the bag, box or bucket in an effort to evenly distribute the single streaming butter over the top layers). In addition this approach wastes butter, napkins and other resources. In addition, the patron usually has to spill some popcorn into the garbage to shake the bag, box or bucket to try to better distribute the butter to lower layers.

Furthermore, there is no real choice as to the butter available at theaters. It is either the one kind of butter in the machine or no butter at all. There are no alternative choices as to flavor or caloric characteristics. The machines frequently run out of butter and need to be refilled by theater staff. This generally results in delays, longer lines, and missed previews or features.

Some theaters maintain these butter-dispensing machines “behind the counter” whereby theater workers operate them as patrons request. Though this provides some control over the often messy machine, it has numerous shortcomings. Firstly, it is a difficult transaction for the theater employee to butter the patron's popcorn to the satisfaction of the patron. Either the patron settles for how the employee butters the popcorn or the patron coaches the employee through the patron's preferences. The patron is usually less than satisfied, and the line of patrons waiting for service grows and grows. These are unnecessary transactions, complications, and dissatisfactions.

Various patents show disposable packets or containers that are pre-filled with a food topping. For example, the Campbell patent (U.S. Pat. No. 4,648,506) discloses a package and spreader for storing and delivering spreadable materials such as butter. U.S. Pat. No. 3,428,460 to Ely is directed to a container type stirrer that includes compartments for storing dry ingredients to be added to a beverage, such as coffee. Also, U.S. Pat. No. 4,854,466 to Lane discloses a packaging cup to contain a condiment and hang from another container. However, none of these devices are suitable for storing and dispensing butter-flavored popcorn topping in a way that addresses the problems discussed above.

### SUMMARY OF THE INVENTION

In view of the foregoing background, it is therefore an object of the present invention to provide a disposable pre-filled topping dispenser which can be used for any and all popcorn uses (theater, home, traveling, fairs etc.). The disposable topping dispenser can also be used to contain and make portable other condiments such as sauces, dressings, or toppings for other food.

This and other objects, features, and advantages in accordance with the present invention are provided by a disposable prefilled food condiment dispenser including an elongated hollow agitator having an openable end and another end connected to a reservoir filled with a food condiment, such as butter-flavored popcorn topping. A passageway extends between the ends of the hollow agitator. A food container clip or other attachment device may extend from one of the agitator and the reservoir to removably attach the dispenser to a food container. The openable end of the elongated hollow agitator preferably has an opening and a removable cap or seal closing the opening. The seal may be a removable seal or a breakable seal, for example. The elongated hollow agitator and the reservoir may be integrally formed as a monolithic unit, for example, of plastic or paper. Also, the elongated hollow agitator is preferably a substantially rigid hollow tube, and the reservoir is preferably a flexible hollow bulb.

Objects, features, and advantages in accordance with the present invention are also provided by a method of dispensing a food condiment, such as butter-flavored popcorn topping, on a food (e.g. popcorn in a container) including providing a disposable popcorn topping dispenser having a reservoir, prefilled with popcorn topping. An elongated hollow agitator having an openable distal end may be connected to the reservoir. The method includes opening the openable dispenser, positioning the dispenser at a desired position adjacent the popcorn in the container, and compressing the reservoir to dispense the butter-flavored popcorn topping on the popcorn in the container. Preferably, dispensing the topping includes agitating the popcorn in the container with the elongated hollow agitator. Again, a popcorn container attachment device may be provided to removably attach the dispenser to the popcorn container.

Advantages include the availability of butter that can easily be distributed throughout a popcorn bag, box or bucket. The popcorn can be easily buttered in a darkened theater, and it can be done all at once, or periodically, depending upon the preferences of the user. The popcorn can be shared by patrons with different butter preferences, by pinpointing rather easily which portions to butter and to what degree. The invention is not messy. The dispenser is portable, and it does not require the shaking and spilling of popcorn, and it does not result in a situation where butter is routinely spilled on the outside of the popcorn container. The invention provides for the availability of different flavors and different caloric choices, and eliminates the need for assistance from theater employees and the need to revisit the butter machines to re-butter the popcorn after purchase.

### BRIEF DESCRIPTION OF THE DRAWINGS

FIG. 1 is a perspective view of a disposable food condiment dispenser in accordance with a first embodiment of the present invention.

FIG. 2 is cross-sectional view of the dispenser of the first embodiment of FIG. 1.

FIG. 3 is a perspective view of a disposable food condiment dispenser in accordance with a second embodiment of the present invention.

FIGS. 4-6 are perspective views of the dispenser being used in connection with a container in accordance with a method of the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

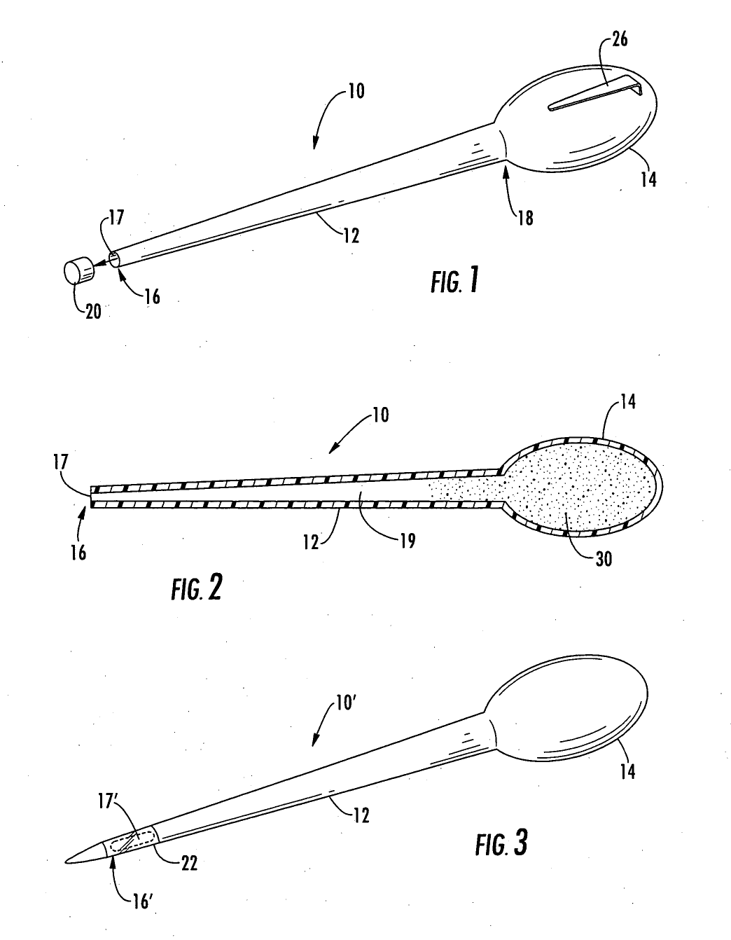

Referring initially to FIGS. 1 and 2, a disposable pre-filled food condiment dispenser 10 in accordance with the present invention will be described. The preferred embodiment and the description that follows refers primarily to butter-flavored popcorn topping for dispensing on popcorn, e.g. in a bag or bucket served in a theater. However, the disposable topping dispenser 10 can be used to contain and make portable various condiments such as sauces, dressings, or toppings for any food. For example, those skilled in the art will appreciate that such a dispenser could be used to contain and dispense salad dressing on and within a salad to thereby obviate the need to “toss” the salad.

The disposable prefilled food condiment dispenser 10 includes an elongated hollow agitator 12 having an openable end 16 and another end 18 connected to a reservoir 14 filled with a food condiment 30, such as butter-flavored popcorn topping. A passageway 19 extends between the ends 16, 18. The openable end 16 of the elongated hollow agitator 12 preferably has an opening 17 and a removable cap 20. The removable cap 20 would preferably be secured on the openable end 16 via a friction fit, snap fit, tongue and groove or threads etc., for example, as would be appreciated by those skilled in the art.

The elongated hollow agitator 12 and the reservoir 14 may be integrally formed as a monolithic unit, for example, of plastic, paper (e.g. polycoated paper or paperboard) or any other suitable food grade material having the appropriate characteristics described below. Preferably, and as illustrated, the elongated hollow agitator 12 is a substantially rigid hollow tube, and the reservoir 14 is a flexible hollow bulb. Of course, other shapes and cross-sections of the reservoir 14 and elongated hollow agitator 12 could be used as long as the food condiment 30 can be stored and dispensed as described herein.

A clip 26 extends from the agitator 12 or the reservoir 14 (as shown) to removably attach the dispenser 10 to a food container. Such a clip may also be integrally formed with the dispenser, e.g. of plastic. The dispenser 10 may then be attached with the clip 26 to the inside or outside of a food container, such as a popcorn bucket or bag, when not in use. Preferably, the dispenser 10 is clipped to the inside of the bucket or bag so that it is out of the way, it will not fall to the floor or tip the container over, and it discourages users from throwing it on the floor. This is one of the features that allows the invention to minimize messes while encouraging conscientious users to avoid littering which is a recognized problem at movie theaters. As would be appreciated by the skilled artisan, other attachment devices could be used as may be desired when using the dispenser 10 with various popcorn containers or any other food containers, for example, a salad bowl.

Also, referring to another embodiment of the dispenser 10′ illustrated in FIG. 3, the opening 17′ may be on the side of the openable end 16′ and/or include a seal 22, such as a removable seal or a breakable seal, closing the opening. The openable end 16′ may also have a plurality of openings 17′ or holes closed by one or more seals, as would be appreciated by those skilled in the art.

Use of the dispenser 10, 10′ will now be described with reference to FIGS. 4-6. The method of dispensing a food condiment, such as butter-flavored popcorn topping, on a food, e.g. popcorn 42 in a container 40, includes providing a disposable butter-flavored popcorn topping dispenser 10, 10′ having a reservoir 14, prefilled with butter-flavored popcorn topping 30, and connected to a proximal end 18 of the elongated hollow agitator 12 having an openable distal end 16, 16′ opposite the proximal end. The method includes opening the openable distal end 16, 16′ of the elongated hollow agitator, such as by removing the cap 20 or seal 22, and positioning the elongated hollow agitator 12 at a desired position adjacent the popcorn 42 in the container 40, e.g. above the top portion of popcorn in the container (FIG. 4). Compressing (i.e. squeezing) the reservoir 14 dispenses the topping 30 via the passageway 19 of the elongated hollow agitator 12 and the openable distal end 16, 16′ thereof. Of course the user may move the dispenser 10, 10′ over the popcorn 42 while dispensing the topping 30 as desired. Alternatively, a push button, e.g. as used in connection with laboratory pipettes, may be provided with the reservoir 14 to more accurately control the amount of topping 30 being dispensed.

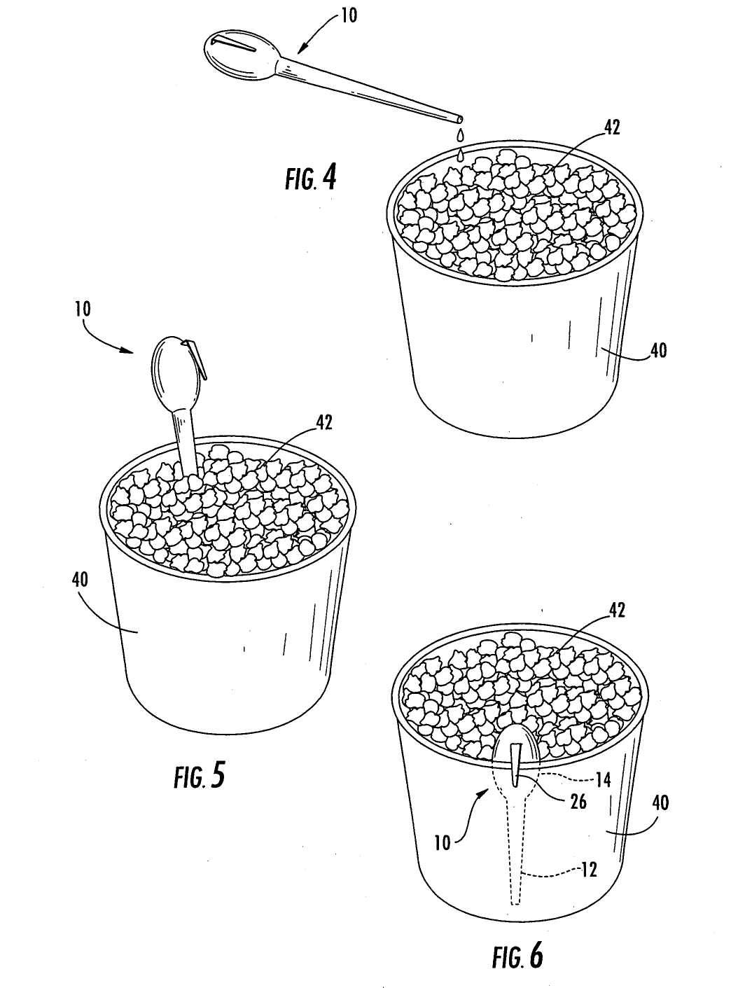

While holding the dispenser 10, 10′ by the reservoir 14 and/or proximal end 18, the user may reposition the dispenser by inserting such into the popcorn 42 so that the openable end 16, 16′ is adjacent lower layers of popcorn in the container 40. The user may then move the dispenser 10, 10′ to agitate the popcorn with the elongated hollow agitator 12 while continuing to dispense the butter 30 in accordance with the user's tastes and preferences. Again, a popcorn container clip 26 may be provided to removably attach the dispenser to the inside or outside of the popcorn container 40 as illustrated, for example, in FIG. 6.

As should be appreciated, butter is easily distributed throughout a popcorn bag, box or bucket 40. The popcorn 42 can be easily buttered in a darkened theater, and it can be done all at once, or periodically, depending upon the preferences of the user. The popcorn 42 can be shared by patrons with different butter preferences, by pinpointing rather easily which portions to butter and to what degree. The dispenser 10, 10′ is not messy and helps minimize messes in a theater or home. The dispenser 10, 10′ is portable, and it does not require the shaking and spilling of popcorn 42, and it does not result in a situation where butter 30 is routinely spilled on the outside of the popcorn container 40.

The invention provides for the availability of different sizes (e.g. corresponding to different size popcorn containers), different flavors (e.g. garlic butter, caramel etc.) and different caloric choices (e.g. low fat, no-fat etc.), and eliminates the need for assistance from theater employees and the need to revisit a butter machine to re-butter the popcorn 42 after purchase.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A disposable prefilled popcorn topping dispenser comprising:
an elongated hollow agitator having an openable first end and a second end with a passageway extending therebetween; and
a reservoir, filled with popcorn topping, connected to the second end of the elongated hollow agitator and in fluid communication with the passageway therein.

2. The disposable prefilled popcorn topping dispenser according to claim 1 further comprising a popcorn container clip extending from one of the elongated hollow agitator and the reservoir to removably attach the dispenser to a popcorn container.

3. The disposable prefilled popcorn topping dispenser according to claim 1 wherein the openable first end of the elongated hollow agitator comprises at least one opening and a removable cap closing the at least one opening.

4. The disposable prefilled popcorn topping dispenser according to claim 1 wherein the openable first end of the elongated hollow agitator comprises at least one opening and a seal closing the at least one opening.

5. The disposable prefilled popcorn topping dispenser according to claim 1 wherein the elongated hollow agitator and the reservoir are integrally formed as a monolithic unit.

6. The disposable prefilled popcorn topping dispenser according to claim 5 wherein the monolithic unit comprises at least one of plastic and paper.

7. The disposable prefilled popcorn topping dispenser according to claim 1 wherein the elongated hollow agitator comprises a substantially rigid hollow tube.

8. The disposable prefilled popcorn topping dispenser according to claim 1 wherein the reservoir comprises a flexible hollow bulb.

9. A disposable prefilled food condiment dispenser comprising:
an elongated hollow agitator having an openable first end and a second end with a passageway extending therebetween; and
a reservoir, filled with a food condiment, connected to the second end of the elongated hollow agitator and in fluid communication with the passageway therein.

10. The disposable prefilled food condiment dispenser according to claim 9 further wherein the openable first end of the elongated hollow agitator comprises at least one opening and a removable cap closing the at least one opening.

11. The disposable prefilled food condiment dispenser according to claim 9 wherein the openable first end of the elongated hollow agitator comprises at least one opening and a seal closing the at least one opening.

12. The disposable prefilled food condiment dispenser according to claim 9 wherein the elongated hollow agitator and the reservoir are integrally formed as a monolithic unit.

13. The disposable prefilled food condiment dispenser according to claim 9 further comprising a food container clip extending from at least one of the elongated hollow agitator and the reservoir to removably attach the dispenser to a food container.

14. The disposable prefilled food condiment dispenser according to claim 9 wherein the elongated hollow agitator comprises a substantially rigid hollow tube.

15. The disposable prefilled food condiment dispenser according to claim 9 wherein the reservoir comprises a flexible hollow bulb.

16. A popcorn serving system comprising:
a popcorn container; and
a prefilled popcorn topping dispenser comprising
an elongated hollow agitator having an openable first end and a second end with a passageway extending therebetween,
a reservoir, filled with popcorn topping, connected to the second end of the elongated hollow agitator and in fluid communication with the passageway therein, and
a popcorn container clip extending from one of the elongated hollow agitator and the reservoir to removably attach the dispenser to the popcorn container.

17. The system according to claim 16 wherein the openable first end of the elongated hollow agitator comprises at least one opening and a removable cap closing the at least one opening.

18. The system according to claim 16 wherein the openable first end of the elongated hollow agitator comprises at least one opening and a seal closing the at least one opening.

19. The system according to claim 16 wherein the elongated hollow agitator and the reservoir are integrally formed as a monolithic unit.

20. The system according to claim 16 wherein the elongated hollow agitator comprises a substantially rigid hollow tube.

21. The system according to claim 16 wherein the reservoir comprises a flexible hollow bulb.

22. A food serving system comprising:
a food container; and
a prefilled food topping dispenser comprising
an elongated hollow agitator having an openable first end and a second end with a passageway extending therebetween,
a reservoir, filled with food topping, connected to the second end of the elongated hollow agitator and in fluid communication with the passageway therein, and
a food container attachment device to removably attach the dispenser to the popcorn container.

23. The system according to claim 22 wherein the openable first end of the elongated hollow agitator comprises at least one opening and a removable cap closing the at least one opening.

24. The system according to claim 22 wherein the openable first end of the elongated hollow agitator comprises at least one opening and a seal closing the at least one opening.

25. The system according to claim 22 wherein the elongated hollow agitator comprises a substantially rigid hollow tube.

26. The system according to claim 22 wherein the reservoir comprises a flexible hollow bulb.

27. A method of portably dispensing popcorn topping on popcorn in a container comprising:
providing a portable disposable popcorn topping dispenser including a reservoir prefilled with popcorn topping;
opening the portable disposable popcorn topping dispenser;
positioning the portable disposable popcorn topping dispenser at a desired position adjacent the popcorn in the container; and
dispensing the popcorn topping on the popcorn in the container.

28. The method according to claim 27 further comprising providing a popcorn container attachment device to removably attach the dispenser to the popcorn container.

29. The method according to claim 27 wherein the portable disposable popcorn topping dispenser further includes an elongated hollow agitator having a proximal end connected to the reservoir and an openable distal end opposite the proximal end.

30. The method according to claim 29 wherein the openable distal end of the elongated hollow agitator comprises at least one opening.

31. The method according to claim 29 wherein dispensing the popcorn topping includes agitating the popcorn in the container with the elongated hollow agitator.

32. The method according to claim 27 wherein the elongated hollow agitator comprises a substantially rigid hollow tube.

33. The method according to claim 27 wherein the reservoir comprises a flexible hollow bulb.
